(19) United States
(12) Patent Application Publication
(10) Pub. No.: US 2002/0152352 A1
(43) Pub. Date: Oct. 17, 2002

(54) High-speed information retrieval system

(75) Inventors: Yasuyuki Ikegai, Tokyo (JP); Teruo Kaganoi, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/117,197

(22) Filed: Apr. 8, 2002

(30) Foreign Application Priority Data
Apr. 13, 2001 (JP) 2001-115468

(51) Int. Cl. G06F 12/00

(52) U.S. Cl. 711/108; 711/154

(57) ABSTRACT

An information retrieval system includes two content addressable memories to be searched for m-bit/n-bit codes identical with m-bit/n-bit retrieval key sub-codes, a data memory storing pieces of information relating to different retrieval keys expressed by the combinations of the m-bit/n-bit codes in addressable memory locations assigned addresses, respectively, and an address generating unit supplied with addresses of the m-bit/n-bit codes identical with the m-bit/n-bit retrieval key sub-codes from the content addressable memories so as to generate a target address from the addresses for accessing the piece of information relating to a given retrieval key, whereby the two content addressable memories are searched for the m-bit/n-bit codes substantially in parallel.

### FIELD OF THE INVENTION

This invention relates to an information retrieval system and, more particularly, to an information retrieval system for pieces of data information represented by data codes greater in bit width than the retrieval code.

### DESCRIPTION OF THE RELATED ART

A content addressable memory has plural memory locations which are identified by the content rather than by their specific address. The content addressable memory is usually abbreviated as “CAM”. When a user retrieves a piece of information relating to a word, he or she gives a retrieval key code representative of the word to the content addressable memory. Then, a memory location is selected from the content addressable memory, and the piece of information is read out from the memory location.

The content addressable memories are incorporated in an information retrieval system. When a user inputs a retrieval key, the information retrieval system outputs pieces of data identical with or analogous to the retrieval key. The information retrieval system may output the address or addresses where the pieces of data are stored. The retrieval key is represented by a binary code, the bit width of which is equal to the bit width of data words. If a user wants to retrieve pieces of data with a retrieval key longer in bit width than the data words, the information retrieval system divides the retrieval key into plural key parts, and repeatedly searches the content addressable memory for the plural key parts. Thus, the retrieval keys or key parts correspond to contents registered in the content addressable memory, respectively. For this reason, a management for registered contents in the content addressable memory and an addressing technique for memory locations are required for the information retrieval system. An addressing system is disclosed in Japanese Patent Application laid-open No. 11-273363. The addressing system is incorporated in a prior art information retrieval system, and includes an address comparator. The address comparator has two input ports, one of which is connected to a content addressable memory, and the other of which is connected to another content addressable memory. The prior art information retrieval system determines the address of a memory location where the piece of data information is stored.

FIG. 1 shows the prior art information retrieval system. The prior art information retrieval system includes a data input buffer 101, content addressable memories 102a and 102b, an address register 103, a data memory 104 and an address comparator 105. The retrieval key has a bit width equal to the total bit width of the contents stored in the content addressable memories 102a/102b. The retrieval key is supplied to the data input buffer 101, and is stored therein. The retrieval key is representative of a content, and the content is expressed by N-bit retrieval code.

The content addressable memory 102a has plural memory locations, and the other content addressable memory 102b also has plural memory locations. The memory locations of the content addressable memory 102a are respectively corresponding to the memory locations of the other content addressable memory 102b. Addresses “0”, . . . “k”, “k+1”, “k+2”, “k+3”, “k+4”, k+5”, . . . are assigned to the memory locations of the content addressable memory 2a and the corresponding memory locations of the other content addressable memory 2b (see FIG. 2). Thus, the address is shared between the two content addressable memories 2a and 2b. Sub-contents “AA”, “BB”, “CC” . . . are selectively stored in the memory locations of the content addressable memory 2a, and are expressed by m-bit codes. On the other hand, sub-contents “aa”, “bb”, “cc”, . . . are selectively stored in the memory locations of the other content addressable memory 2b, and are expressed by n-bit codes. The total bit width of each n-bit code and the corresponding m-bit code is equal to the N-bit retrieval code.

The data input buffer 101 divides the N-bit retrieval code into two sub-codes representative two parts of the retrieval key. One of the sub-codes consists of m-bits, and the other sub-code consists of n-bits. The two sub-codes are output from the data input buffer 101 to the content addressable memories 102a and 102b, respectively. When the sub-code is hit on an m-bit code or n-bit code stored in the memory locations, the content addressable memory 102a/102b transfers the address assigned the memory location storing the m-bit code/n-bit code to the other content addressable memory 102b/102a and the address comparator 105. The other content addressable memory searches the memory locations for the other sub-code. When the other sub-code is hit on an n-bit code/m-bit code stored in the memory location, the other content addressable memory transfers the address to the content addressable memory and the address comparator 105. The address comparator 105 compares the addresses respectively supplied from the content addressable memories 102a/102b to see whether or not the addresses are consistent with each other. If the answer is given negative, the content addressable memories 102a/102b continue the retrieval. On the other hand, when the answer is given affirmative, the address is transferred to the address register 103, and a piece of data information is read out from the address in the data memory 104. Thus, even though the retrieval code is wider in bit width than the sub-codes, the prior art information retrieval system retrieves the piece of data information relating to the retrieval key.

FIG. 3 shows a flow of retrieving operation in the prior art information retrieval system. The data retrieval is described in detail with concurrent reference to FIGS. 1, 2 and 3. The retrieval key is assumed to be represented by the retrieval code “CCaa”. The m-bit sub-code and the n-bit sub-code are representative of the key part “CC” and the other key part “aa”.

When the retrieval key reaches the data input buffer 101, the retrieval key is stored in the data input buffer 101, and is divided into two key parts, i.e., the m-bit sub-code “CC” and the n-bit sub-code “aa”. The key parts are hereinbelow also labeled with “CC” and “aa”. The key parts “CC” and “aa” are supplied from the data input buffer 101 to the content addressable memories 102a and 102b.

First, the content addressable memory 102a is activated, and the content addressable memory 102a is searched for an m-bit code “CC” from address “0” toward the end. When the address is incremented to “k+1”, the content addressable memory 102a finds the m-bit code identical with the key part “CC”. Then, the address “k+1” is transferred to the address comparator 105 and the other content addressable memory 102b. The content addressable memory 102a stops the retrieval.

The content addressable memory 102bstarts the search at address “k+1”. When the address is incremented to “k+2”, the content addressable memory 102b find the n-bit code identical with the other key part “aa”. Then, the content addressable memory 102b transfers the address “k+2” to the other content addressable memory 102a and the address comparator 105, and stops the retrieval.

The address comparator compares the address “k+1”, which was transferred from the content addressable memory 102a, with the address “k+2” to see whether or not the addresses are consistent with each other. The address “k+2” is different from the address “k+1”, and the answer is given negative. The address comparator 105 informs the content addressable memory 102a of the negative answer, and causes the content addressable memory 102a to re-start the retrieval at address “k+2”. When the address is incremented to “k+3”, the content addressable memory 102a finds the m-bit code at address “k+3” identical with the key part “CC”, again. The content addressable memory 102a transfers the address “k+3” to the other content addressable memory 102b and the address comparator 105, and stops the retrieval.

The other content addressable memory 102b restarts the retrieval at address “k+3”, and finds the n-bit code at address “k+4” identical with the key part “aa”. The content addressable memory 102b transfers the address “k+4” to the other content addressable memory 102a and the address comparator, and stops the retrieval.

The address comparator 105 compares the addresses transferred from the content addressable memories 102a/102b to see whether or not the addresses are consistent with each other. The address transferred from the content addressable memory 102a is “k+3”, and the other address, which was transferred from the other content addressable memory 102b is “k+4”. The address comparator 105 finds the addresses inconsistent with each other. The address comparator 105 informs the content addressable memory of the negative answer.

With the negative answer, the content addressable memory 102a restarts the retrieval at address “k+4”, and finds the m-bit code at address “k+5” identical with the key part “CC”. The content addressable memory 102a transfers the address “k+5” to the other content addressable memory 102b and the address comparator 105, and stops the retrieval.

The other content addressable memory 102b restarts the retrieval at address “k+5”, and finds the n-bit code at address “k+5” identical with the key part “aa”. The content addressable memory 102b transfers the address “k+5” to the other content addressable memory 102a and the address comparator 105, and stops the retrieval.

The address comparator 105 compares the addresses to see whether or not the addresses are consistent with each other. The address “k+5”, which was transferred from the content addressable memory 102a is consistent with the address “k+5” transferred from the other content addressable memory 102b, and the answer is changed to affirmative. The address comparator 105 informs the content addressable memory 102a of the positive answer so as not to restart the retrieval, and transfers the address “k+5” to the address register 103.

The address “k+5” is supplied from the address register 103 to the data memory 104, and a piece of data information is read out from the data memory 104. Thus, the content addressable memories 102a/102bare alternately activated for the retrieval, and the start address is given from the previously activated content addressable memory to the other content addressable memory. As a result, the latest addresses at which the key parts are consistent with the m-bit/n-bit codes are taken into account by the address comparator 105.

A problem is encountered in the prior art information retrieval system in that an unfixed long time is consumed until the data memory 104 outputs the piece of data information. This is because of the fact that the content addressable memories 102a/102b alternately retrieve the m-bit/n-bit codes stored therein. The retrieval is to be repeated at least twice. In the case shown in FIG. 3, the retrieval is repeated six times. The time period until the hit is dependent on the memory location where the (m+n)-bit code is stored. This results in the unfixed time period.

Another problem is that a large amount of memory locations are consumed for storing the (m+n)-bit codes. Although the (m+n)-bit codes at addresses “k+1”, “k+3” and “k+5” have the m-bit code “CC”, the associated n-bit codes at these addresses are different from one another, and the m-bit code “CC” is repeatedly stored.

### SUMMARY OF THE INVENTION

It is therefore an important object of the present invention to provide an information retrieval system, which outputs information relating to the retrieval key within a short time period through a retrieving operation on candidates economically stored in memories.

In accordance with one aspect of the present invention, there is provided an information retrieval system for selecting a piece of information relating to a retrieval key code dividable into plural retrieval sub-codes, and the information retrieval system comprises a first memory including plural memory spaces respectively storing plural groups of content codes equal in bit width to the plural retrieval sub-codes and responsive to the plural retrieval sub-codes so as to output plural address codes representative of memory locations respectively selected from the plural memory spaces, content codes identical with the plural retrieval sub-codes being stored in the memory locations, a second memory having plural addressable memory locations for storing pieces of information and responsive to a target address so as to select the piece of information relating to the retrieval key code from the pieces of information and an address generating unit connected to the first memory and the second memory and generating the target address through an arithmetic operation on the address codes so as to supply the target address to the second memory.

### BRIEF DESCRIPTION OF THE DRAWINGS

The features and advantages of the information retrieval system will be more clearly understood from the following description taken in conjunction with the accompanying drawings, in which

FIG. 1 is a block diagram showing the arrangement of the prior art information retrieval system,

FIG. 2 is a timing chart showing the retrieving operation on the content addressable memories incorporated in the prior art information retrieval system,

FIG. 3 is a view showing the prior art retrieval sequence,

FIG. 4 is a block diagram showing the system configuration of an information retrieval system according to the present invention,

FIG. 5 is a timing chart showing a retrieving operation carried out by the information retrieval system according to the present invention,

FIG. 6 is a block diagram showing the system configuration of another information retrieval system according to the present invention,

FIG. 7 is a view showing retrieval key codes used in the retrieval,

FIG. 8 is a view showing the arrangement of content codes, pointer values and pieces of information established in the information retrieval system,

FIG. 9 is a block diagram showing the system configuration of yet another information retrieval system according to the present invention,

FIG. 10 is a view showing the arrangement of content codes, pointer values and pieces of information established in the information retrieval system,

FIG. 11 is a block diagram showing the system configuration of still another information retrieval system according to the present invention,

FIG. 12 is a view showing the arrangement of content codes, pointer values and pieces of information established in the information retrieval system,

FIG. 13 is a block diagram showing the system configuration of yet another information retrieval system according to the present invention,

FIG. 14 is a view showing the arrangement of content codes, pointer values and pieces of information established in the information retrieval system,

FIG. 15 is a block diagram showing the system configuration of still another information retrieval system according to the present invention,

FIG. 16 is a view showing the arrangement of content codes, pointer values and pieces of information established in the information retrieval system,

FIG. 17 is a block diagram showing the system configuration of yet another information retrieval system according to the present invention, and

FIG. 18 is a view showing the arrangement of content codes, pointer values and pieces of information established in the information retrieval system.

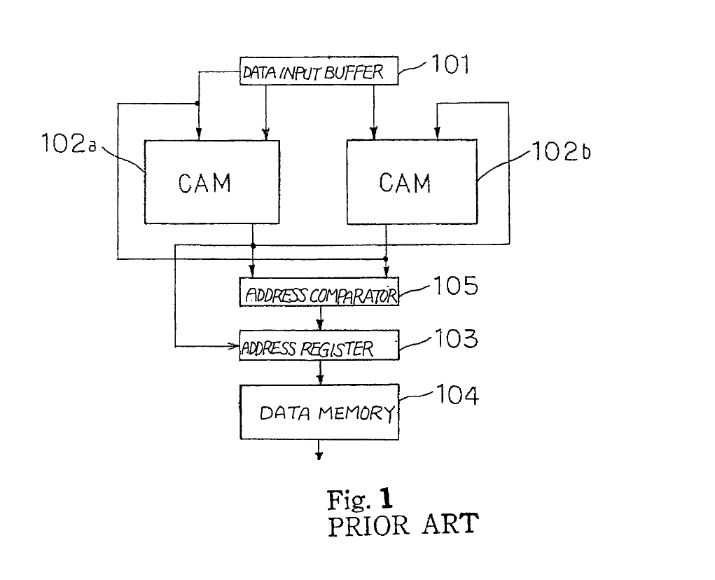

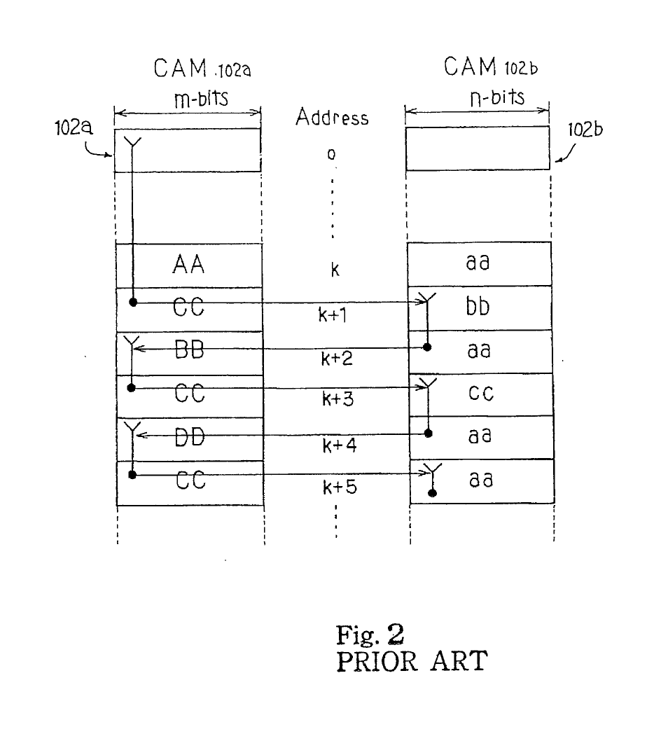

### DESCRIPTION OF THE PREFERRED EMBODIMENTS

First Embodiment

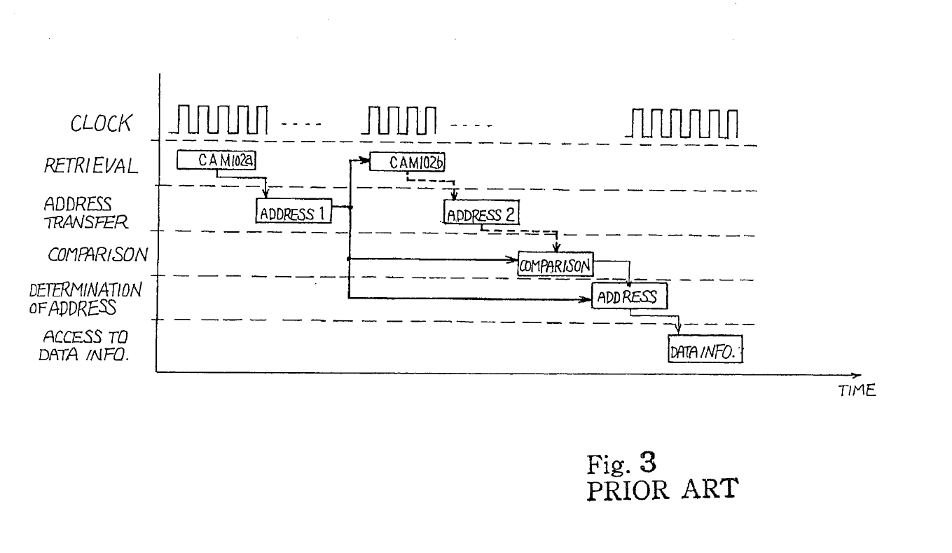

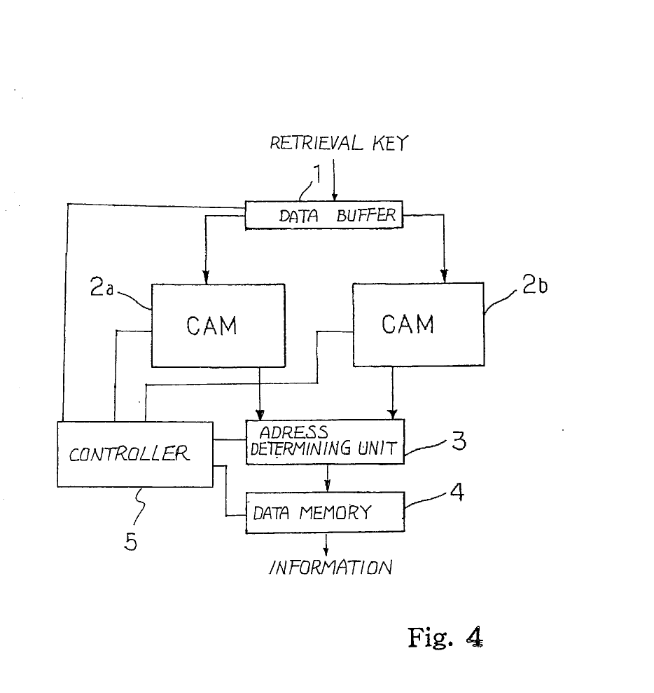

Referring t FIG. 4 of the drawings, an information retrieval system embodying the present invention comprises a data buffer 1, content addressable memories 2a/2b, an address determining unit 3, a data memory 4 and a controller 5. The data buffer 1 has a data input port and two data output ports. A retrieval key is supplied to the data input port of the data buffer 1, and is temporarily stored in the data buffer 1. The retrieval key is expressed by an N-bit retrieval code. The retrieval key is dividable into two key parts, and, accordingly, the N-bit retrieval code is dividable into an m-bit retrieval sub-code and an n-bit retrieval sub-code. The key parts are respectively expressed by the m-bit retrieval sub-code and the n-bit retrieval sub-code, respectively. The m-bit retrieval sub-code and the n-bit retrieval sub-code are output from the two data output ports of the data buffer 1, respectively.

The content addressable memories 2a/2b have respective address ports and respective output ports. The data output ports of the data input buffer 1 are connected to the address ports, respectively, so that the m-bit retrieval sub-code and the n-bit retrieval sub-code are supplied to the address ports of the content addressable memories 2a/2b, respectively.

The content addressable memories 2a/2b are similar in circuit arrangement to each other. Each of the content addressable memories 2a/2b has plural addressable memory locations. The plural memory locations of the content addressable memory 2a are used for storing m-bit codes representative of parts of contents, and addresses are assigned to the memory locations of the content addressable memory 2a, respectively. Similarly, the plural memory locations of the other content addressable memory 2a are used for storing n-bit codes representative of remaining parts of the content, and addresses are assigned to the memory locations of the other content addressable memory 2b. The addresses assigned to the memory locations of the content addressable memory 2a are not identical with the addresses assigned to the memory locations of the content addressable memory 2b. In other words, the m-bit codes correspond to only the addresses in the content addressable memory 2a, respectively, and the n-bit codes also correspond to only the addresses in the content addressable memory 2b. As a result, the content addressable memories 2a/2b are independently searched for the m-bit retrieval sub-code and the n-bit retrieval sub-code. In other words, the retrieval operation is concurrently carried out on the m-bit codes stored in the content addressable memory 2a and the n-bit codes stored in the content addressable memory 2b. When an m-bit code is found to be identical with the m-bit retrieval sub-code, the content addressable memory 2a outputs the address assigned the memory location storing the m-bit code to the output port thereof. Similarly, when an n-bit code is found to be identical with the n-bit retrieval sub-code, the content addressable memory 2b outputs the address assigned the memory location storing the n-bit code to the output port thereof. The address output from the content addressable memory 2a and the address output from the content addressable memory 2b are hereinbelow referred to as “base address” and “offset address”, respectively.

The output ports of the content addressable memories 2a/2b are connected to the input ports of the address determining unit 3. The address determining unit 3 carries out a predetermined calculation on the base address and the offset address, and decides an address where a piece of information, which relates to the retrieval key, is stored. The address, which is determined on the basis of the base address and the offset address, is hereinbelow referred to as “arithmetic address”. The address determining unit 3 outputs the arithmetic address from the output port thereof.

The data memory 4 has an address port and a data output port, and the output port of the address determining unit 3 is connected to the address port of the data memory 4. The data memory has plural addressable memory locations, and pieces of information, which relate to various retrieval keys, are stored in the plural memory locations, respectively. Addresses are assigned to the memory locations of the data memory 4. When the arithmetic address is supplied to the address port, the piece of information is read out from the memory location assigned the address identical with the arithmetic address.

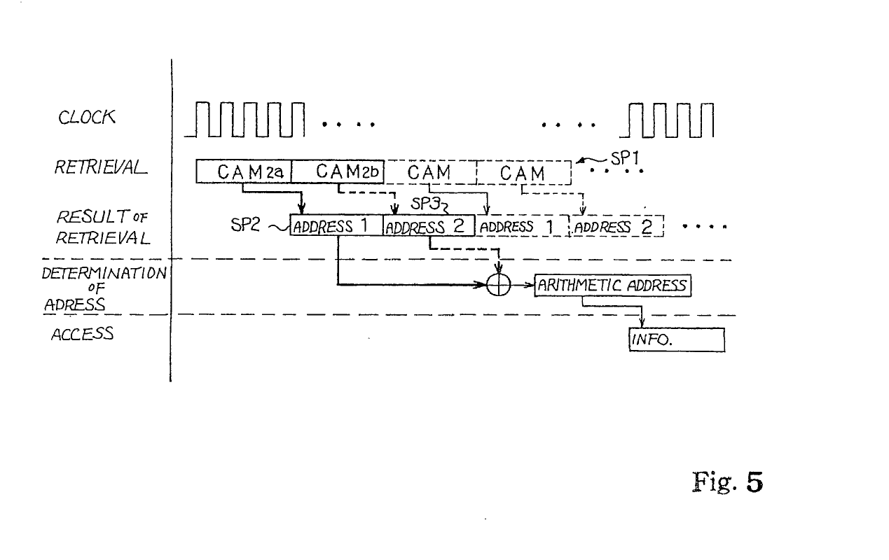

The controller 5 supervises the other system components, i.e., the data buffer 1, content addressable memories 2a/2b, address determining unit 3 and the data memory 4. The other system components 1/2a/2b/3/4 behaves under the supervision of the controller 5 as shown in FIG. 5.

First, an N-bit retrieval key is given to the information retrieval system. The N-bit retrieval key is separated into the m-bit retrieval key part and the n-bit retrieval key part, and are concurrently supplied from the data buffer 1 to the address ports of the content addressable memories 2a/2b. The content addressable memories 2a/2b are searched in parallel for an m-bit code identical with the m-bit retrieval key part and an n-bit code identical with the n-bit retrieval key part as by step SP1. When an m-bit code is found to be identical with the m-bit key part, the base address “address 1” is supplied from the content addressable memory 2a to the address determining unit 3 as by step SP2. Similarly, when an n-bit code is found to be identical with the n-bit key part, the offset address “address 2” is supplied from the content addressable memory 2b to the address determining unit 3 as by step SP3. If more than one n-bit code is found to be identical with the n-bit key part, these are supplied from the content addressable memory 2b to the address determining unit 3 at step SP3. When all the m-bit codes are checked, the content addressable memory 2a terminates the retrieving operation at the last address. Similarly, when all the n-bit codes are checked, the content addressable memory 2b terminates the retrieving operation at the last address. Thus, the time period consumed in the retrieval is estimable.

As will be understood from the foregoing description, the data memory is addressed with the arithmetic address calculated on the basis of the addresses assigned to the memory locations of the plural content addressable memories 2a/2b. The content addressable memories 2a/2b are searched substantially in parallel for the codes identical with the retrieval sub-codes. Each of the content addressable memories 2a/2b is searched for the code identical with the associated one of the retrieval sub-codes only once. The time consumed in the retrieval is estimable. Thus, the information retrieval system according to the present invention offers a piece of pieces of information relating to the retrieval key within a fixed short time period.

The contents are expressed by the combinations between the m-bit codes and the n-bit codes. If an m-bit code is, by way of example, shared between several contents, the m-bit code is stored at a certain address without any duplication to other addresses. This results in that the manufacturer reduces the memory capacity of the content addressable memories 2a/2b.

The content addressable memories 2a/2b may be replaced with a single CAM with a pipeline architecture. In this instance, m-bit codes and n-bit codes are stored in different memory spaces. However, the memory spaces are serially searched in the pipeline fashion. Thus, only one pipeline content addressable memory is available for the information retrieval system without reducing the throughput.

Second Embodiment

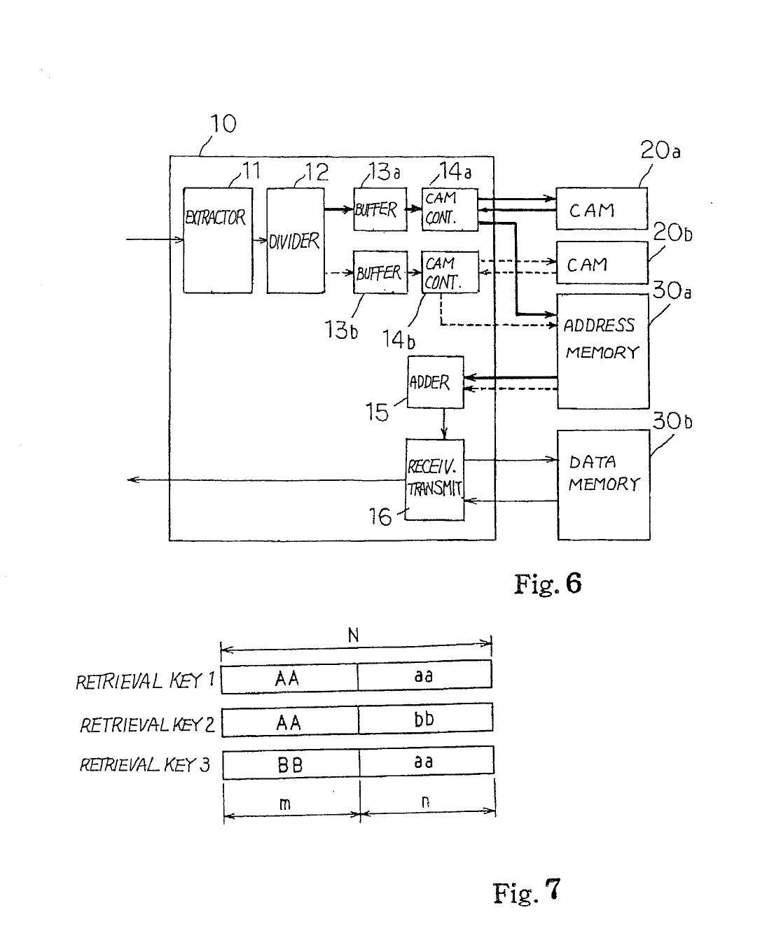

Turning to FIG. 6 of the drawings, another information retrieval system embodying the present invention comprises a retrieval controller 10, content addressable memories 20a/20b, an address memory 30a and a data memory 30b. The information retrieval system carries out a retrieving operation with a retrieval key expressed by N-bits retrieval code. Each of the retrieval keys is dividable into key parts expressed by an m-bit retrieval sub-code and an n-bit retrieval sub-code as shown in FIG. 7. Three retrieval keys 1, 2 and 3 are shown in FIG. 7. The first retrieval key 1 consists of the m-bit retrieval key part “AA” and the n-bit retrieval key part “aa”, the second retrieval key 2 consists of the m-bit retrieval key part “AA” and the n-bit retrieval key part “bb”, and the third retrieval key 3 consists of the m-bit retrieval key part “BB” and the n-bit retrieval key part “aa”.

The content addressable memories 20a/20b has plural addressable memory locations. Parts of contents are expressed by m-bit codes, respectively, and the m-bit codes are stored in the plural addressable memory locations of the content addressable memory 20a, respectively. The remaining parts of the contents are expressed by n-bit codes, respectively, and the n-bit codes are stored in the plural addressable memory locations of the content addressable memory 20b, respectively. Thus, the (m+n)-bit codes are representative of the contents. The content addressable memory 20a is to be searched with the key part represented by the m-bit retrieval sub-code for an m-bit code identical therewith, and the other content addressable memory 20b is to be searched with the remaining key part represented by the n-bit retrieval sub-code for an n-bit code identical therewith.

The address memory 30a has two memory spaces. One of the memory spaces is assigned to pointer values for the memory locations of the content addressable memory 20a, and the other memory space is assigned to pointer values for the memory locations of the other content addressable memory 20b. The pointer values are stored at the addresses identical with those assigned to the memory locations of the content addressable memories 20a/20b. The memory space assigned to the pointer values for the content addressable memory 20b is spaced from the memory space assigned to the pointer values for the other content addressable memory 20a by γ.

The data memory 30b has plural addressable memory locations, and pieces of information are stored in the plural addressable memory locations. The pieces of information relate to retrieval keys. Addresses are assigned to the plural memory locations where the pieces of information are stored. In order to make the addresses distinguishable, the addresses assigned to the memory locations of the data memory 30b are hereinbelow referred to as “object addresses”.

The controller 10 includes a retrieval key extractor 11, a retrieval key divider 12, data buffers 13a/13b, CAM controllers 14a/14b, an adder 15 and a data receiver and transmitter 16. Though not shown in FIG. 6, a signal input port is connected to the retrieval key extractor. A request signal for information retrieval is supplied to the retrieval key extractor 11, and the retrieval key extractor 11 extracts the N-bit retrieval code from the request signal. The retrieval key extractor 11 is connected to the retrieval key divider 12, and the N-bit retrieval code or the N-bit retrieval key is supplied from the retrieval key extractor 11 to the retrieval key divider 12. The retrieval key divider 12 divides the N-bit retrieval code into the m-bit retrieval sub-code and the n-bit retrieval sub-code, i.e., the m-bit retrieval key part and the n-bit retrieval key part.

The retrieval key divider 12 has two output ports, which are respectively connected to the data buffers 13a/13b. The m-bit retrieval sub-code is supplied to the data buffer 13a, and is stored therein. On the other hand, the n-bit retrieval sub-code is supplied to the data buffer 13b, and is stored therein. The data buffers 13a/13b are respectively connected to the CAM controllers 14a/14b, and the m-bit retrieval sub-code and the n-bit retrieval sub-code are supplied to the CAM controllers 14a/14b, respectively.

The CAM controller 14a is associated with the content addressable memory 20a, and the other CAM controller 14b is associated with the other content addressable memory 20b. The CAM controllers 14a/14b are further connected to the address memory 30a, and the address memory 30a is connected to the adder 15. The CAM controllers 14a/14b search the associated content addressable memories 20a/20b for m-bit/n-bit codes identical with the m-bit/ n-bit retrieval sub-codes, and specifies the addresses where the m-bit/n-bit codes are stored. The CAM controllers 14a/14b supplies the addresses to the address memory 30a, and cause the address memory 30a to transfer the pointer values to the adder 15. The adder 15 adds the pointer values to each other, and produces the target address.

The adder 15 has an output port, which is connected to the data receiver and transmitter 16, and the target address is supplied from the adder 15 to the data receiver and transmitter 16. The data receiver and transmitter 16 accesses the memory location assigned the target address, and reads out the piece of information therefrom. The data receiver and transmitter receives the piece of information, and transmits it to the destination.

The information retrieval system behaves as follows. Assuming now that the retrieval request signal carries the retrieval key 1, i.e., the N-bit retrieval code “AAaa” (see FIG. 7), the retrieval key extractor 11 extracts the retrieval key code “AAaa” from the retrieval request signal, and supplies the retrieval key code “AAaa” to the retrieval key divider 12. The retrieval key divider 12 divides the retrieval key code “AAaa” into the m-bit retrieval sub-code “AA” and the n-bit retrieval sub-code “aa”. The m-bit retrieval sub-code “AA” and the n-bit retrieval sub-code “aa” are supplied from the retrieval key divider 12 to the data buffers 13a/13b. The m-bit retrieval sub-code “AA” and the n-bit retrieval sub-code “aa” are stored in the data buffers 13a/13b, respectively.

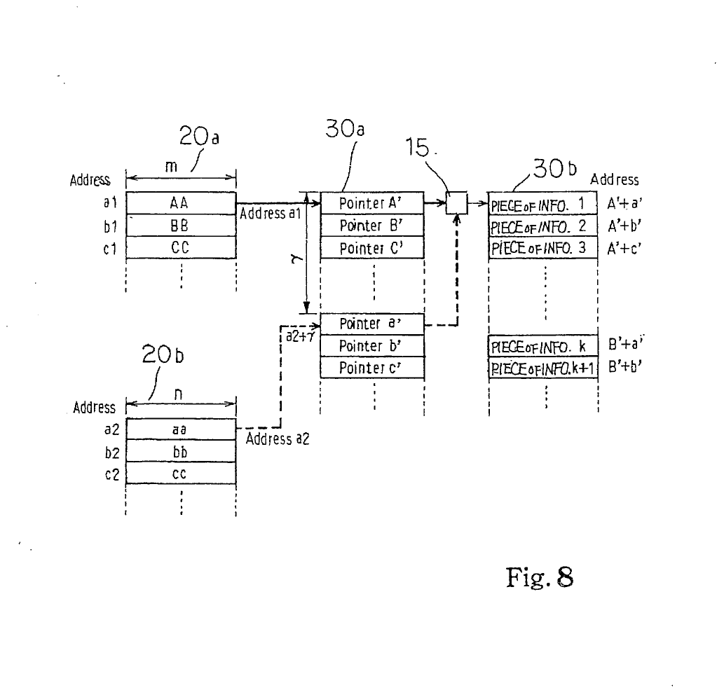

The m-bit codes “AA”, “BB”, “CC”, . . . , n-bit data codes “aa”, “bb”, “cc”, . . . , pointer values “A′”, “B′”, “C′”, . . . ,“a′”, “b′”, “c′”, . . . and the pieces of information “1”, “2”, “3”, . . . “k”, “k+1” . . . are stored in the content addressable memories 20a/20b, the address memory 30a and the data memory 30b as shown in FIG. 8.

The m-bit retrieval sub-code “AA” and n-bit retrieval sub-code “aa” are supplied to the CAM controllers 14a/14b, respectively, and the CAM controllers 14a/14b search the content addressable memories 20a/20b for m-bit/n-bit codes identical with the m-bit/n-bit retrieval sub-codes “AA” and “aa”. The m-bit code “AA” is stored in the memory location at address “a1”, and the n-bit code “aa” is stored in the memory location at address “a2”. When the retrieval key parts are hit on these codes, the content addressable memories 20a/20b transfer the addresses “a1” and “a2” to the CAM controllers 14a/14b, respectively.

As described hereinbefore, the memory space assigned to the addresses in the content addressable memory 20a is spaced from the memory space assigned to the addresses in the other content addressable memory 20b by γ. The CAM controller 14b adds γ to address “a”, and supplies the address “a2+γ” to the address memory 30a. On the other hand, the CAM controller 14a supplies the address “a1” to the address memory 30a. The pointer values “A′ ” and “a′” are specified with the addresses “a1” and “a2+γ”, respectively, and are supplied to the adder 15. The address “a1′” serves as the base address, and the other address “a′” as the offset address. The adder 15 calculates the target address, i.e., the arithmetic address “A′+a′”, and supplies the target address “A′+a′” to the data receiver and transmitter 16. The thick real lines are indicative of the retrieving operation for the key part “AA”, and the broken lines are indicative of the retrieving operation for the key part “aa”.

The data receiver and transmitter 16 accesses the piece of information “1” stored at the target address “A′+a′”, and the pieces of information “1” is transferred to the destination.

Thus, the retrieving operation is carried out substantially in parallel on the content addressable memories 20a/20b, and the memory locations in the content addressable memories 20a/20b are searched for the m-bit/n-bit codes only once. This results in reduction in time period consumed in the retrieval, and the time period is constant.

Third Embodiment

Turning to FIG. 9 of the drawings, yet another information retrieval system embodying the present invention comprises a retrieval controller 110, a content addressable memory 20, an address memory 30a and a data memory 30b. The information retrieval system carries out a retrieving operation with a retrieval key expressed by N-bits retrieval code. Each of the retrieval keys is dividable into key parts expressed by an m-bit retrieval sub-code and an n-bit retrieval sub-code as similar to those used in the second embodiment. However, the m-bit retrieval sub-codes are equal in bit width to the n-bit retrieval sub-codes, i.e., m=n.

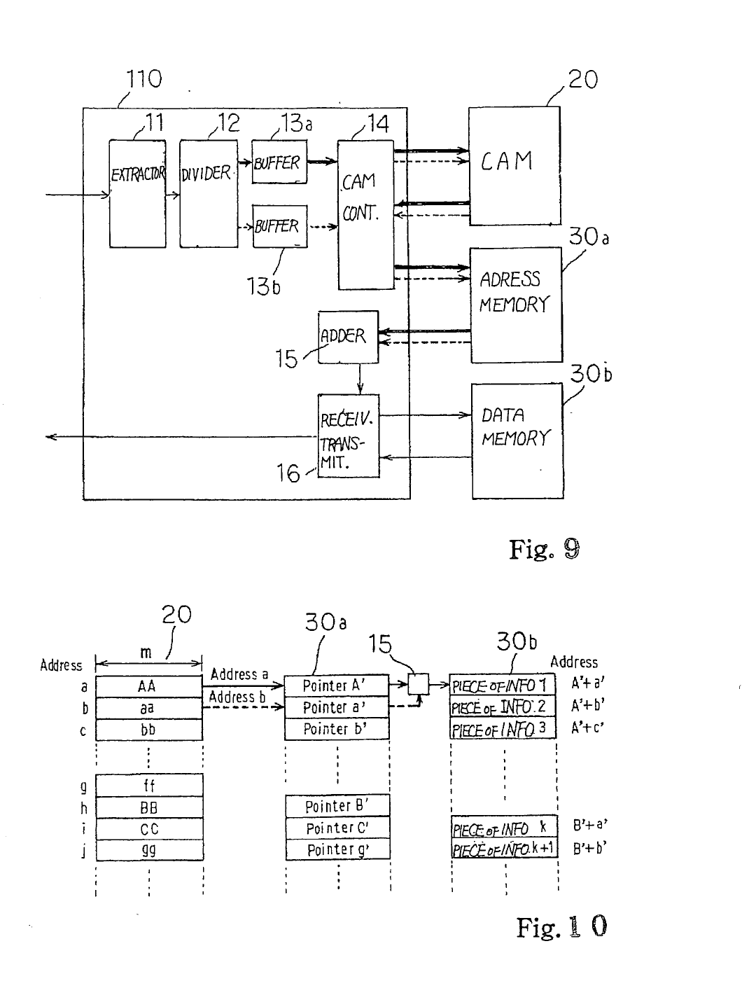

The content addressable memory 20 has plural addressable memory locations. Parts of contents are expressed by m-bit codes, respectively, and the m-bit codes are stored in the memory locations irregularly spaced from one another. The m-bit codes “AA” and “BB” are stored in the memory locations at address “a” and address “h” (see FIG. 10). The remaining parts of the contents are expressed by n-bit codes, respectively, and the n-bit codes are stored in the remaining addressable memory locations of the content addressable memory 20. The n-bits codes to be combined with each m-bit code are grouped so that the n-bit codes form plural code groups. The plural code groups are assigned to the memory spaces between the memory locations assigned to the m-bit codes. Thus, each m-bit code and the associated n-bit codes are stored together in the content addressable memory 20, and addresses “a”, “b”, “c”, . . . “g”, “h”, “I”, “j”, . . . are assigned to the memory locations in the content addressable memory 20. The m-bit codes are equal in bit width to the n-bit codes, i.e., m=n. The content addressable memory 20 is searched for m-bit/n-bit codes identical with the m-bit/n-bit retrieval sub-codes under the control of the CAM controller 14.

The address memory 30a is shared between pointer values for the addresses of the m-bit codes and pointer values for the addresses of the n-bit codes. The pointer values for the addresses of the m-bit codes are stored at the addresses identical with those assigned to the memory locations of the content addressable memory 20. The pointer values for the addresses of the m-bit codes are alternated with the pointer values for the addresses of the n-bit codes.

The data memory 30b has plural addressable memory locations, and pieces of information are stored in the plural addressable memory locations. The pieces of information relate to retrieval keys. Addresses are assigned to the plural memory locations where the pieces of information are stored. Each of the pieces of information is to be designated by using an arithmetic address based on the pointer values.

The controller 110 includes a retrieval key extractor 11, a retrieval key divider 12, data buffers 13a/13b, a CAM controller 14, an adder 15 and a data receiver and transmitter 16. Though not shown in FIG. 9, a signal input port is connected to the retrieval key extractor 11. A request signal for information retrieval is supplied to the retrieval key extractor 11, and the retrieval key extractor 11 extracts the N-bit retrieval code from the request signal. The retrieval key extractor 11 is connected to the retrieval key divider 12, and the N-bit retrieval code or the N-bit retrieval key is supplied from the retrieval key extractor 11 to the retrieval key divider 12. The retrieval key divider 12 divides the N-bit retrieval code into the m-bit retrieval sub-code and the n-bit retrieval sub-code, i.e., the m-bit retrieval key part and the n-bit retrieval key part.

The retrieval key divider 12 has two output ports, which are respectively connected to the data buffers 13a/13b. The m-bit retrieval sub-code is supplied to the data buffer 13a, and is stored therein. On the other hand, the n-bit retrieval sub-code is supplied to the data buffer 13b, and is stored therein. The data buffers 13a/13b are connected to the CAM controllers 14, and the m-bit retrieval sub-code and the n-bit retrieval sub-code are sequentially supplied to the CAM controller 14.

The CAM controller 14 is associated with the content addressable memory 20. The CAM controller 14 is further connected to the address memory 30a, and the address memory 30a is connected to the adder 15. The CAM controller 14 searches the associated content addressable memory 20 for an m-bit code identical with the m-bit retrieval sub-code, and specifies the address where the m-bit code is stored. The CAM controller 14 supplies the address to the address memory 30a, and the pointer value is supplied from the address memory 30a to the adder 15.

The CAM controller 14 further searches the associated content addressable memory 20 for an n-bit code identical with the n-bit retrieval sub-code, and specifies the address where the n-bit code is stored. The CAM controller 14 supplies the address to the address memory 30a, and the pointer value is supplied from the address memory 30a to the adder 15. The adder 15 adds the pointer values to each other, and produces the arithmetic address.

The adder 15 has an output port, which is connected to the data receiver and transmitter 16, and the arithmetic address is supplied from the adder 15 to the data receiver and transmitter 16. The data receiver and transmitter 16 accesses the memory location assigned the arithmetic, address, and reads out the piece of information therefrom. The data receiver and transmitter receives the piece of information, and transmits it to the destination.

The information retrieval system behaves as follows. Assuming now that the retrieval request signal carries the retrieval key 1, i.e., the N-bit retrieval code “AAaa”, the retrieval key extractor 11 extracts the retrieval key code “AAaa” from the retrieval request signal, and supplies the retrieval key code “AAaa” to the retrieval key divider 12. The retrieval key divider 12 divides the retrieval key code “AAaa” into the m-bit retrieval sub-code “AA” and the n-bit retrieval sub-code “aa”. The m-bit retrieval sub-code “AA” and the n-bit retrieval sub-code “aa” are supplied from the retrieval key divider 12 to the data buffers 13a/13b. The m-bit retrieval sub-code “AA” and the n-bit retrieval sub-code “aa” are stored in the data buffers 13a/13b, respectively.

First, the CAM controller 14 fetches the m-bit retrieval sub-code “AA”. The CAM controller 14 searches the content addressable memory 20 for an m-bit code identical with the m-bit retrieval sub-code “AA”. The m-bit code “AA” is stored in the memory location at address “a”. When the retrieval key part “AA” is hit on the m-bit code, the content addressable memory 20 transfers the addresses “a” to the CAM controller 14. The CAM controller 14 supplies the address “a” to the address memory 30a, and the pointer value “A′” is specified with the addresses “a”. The pointer value “A′” is supplied to the adder 15. The address “A′” serves as the base address.

Subsequently, the CAM controller 14 fetches the n-bit retrieval sub-code “aa”. The CAM controller 14 searches the content addressable memory 20 for an n-bit code identical with the n-bit retrieval sub-code “aa”. The n-bit code “aa” is stored in the memory location at address “b”. When the retrieval key part “aa” is hit on the n-bit code, the content addressable memory 20 transfers the address “b” to the CAM controller 14. The CAM controller 14 supplies the address “b” to the address memory 30a, and the pointer value “a′” is specified with the address “b”. The pointer value “a′” is supplied to the adder 15. The address “a′” serves as the offset address.

The adder 15 calculates the target address, i.e., the arithmetic address “A′+a′”, and supplies the target address “A′+a′” to the data receiver and transmitter 16. The thick real lines are indicative of the retrieving operation for the key part “AA”, and the broken lines are indicative of the retrieving operation for the key part “aa”.

The data receiver and transmitter 16 accesses the piece of information “1” stored at the target address “A′+a′”, and the pieces of information “1” is transferred to the destination.

Although the retrieving operation is serially carried out on the content addressable memory 20, twice, the content addressable memory 20a/20 is searched for the m-bit code once, and is partially searched for the n-bit code. This results in reduction in time period consumed in the retrieval.

The retrieval controller 110 requires only one content addressable memory 20 and, accordingly, only one CAM controller 14. Although the time period consumed for the search is slightly longer than that of the second embodiment, the information retrieval system implementing the third embodiment is simpler than the information retrieval system implementing the second embodiment.

Fourth Embodiment

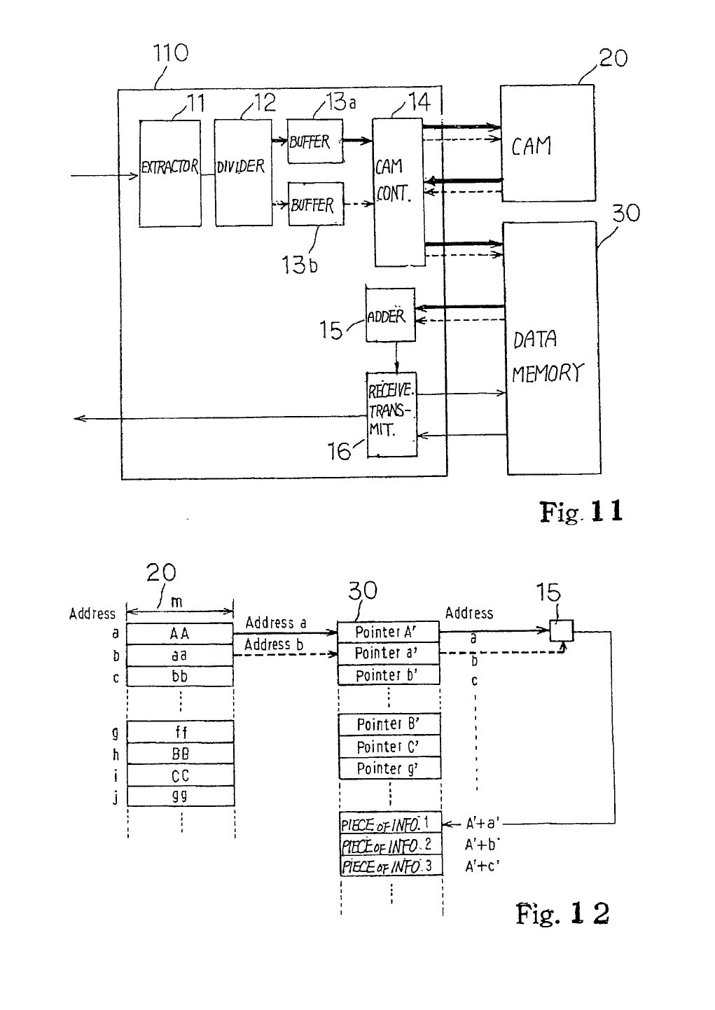

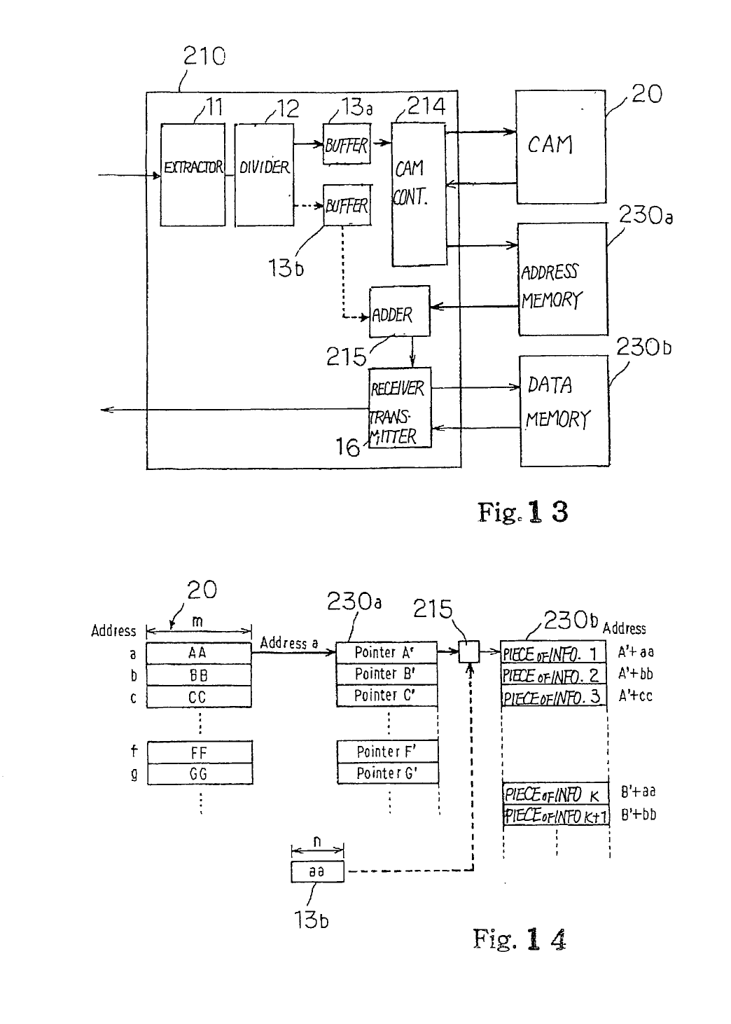

Turning to FIG. 11 of the drawings, still another information retrieval system embodying the present invention comprises a retrieval controller 110, a content addressable memory 20 and a data memory 30. The address memory 30a and the data memory 30b are replaced with a single data memory 30. The information retrieval system carries out a retrieving operation with a retrieval key expressed by N-bits retrieval code. Each of the retrieval keys is dividable into key parts expressed by an m-bit retrieval sub-code and an n-bit retrieval sub-code as similar to those used in the second embodiment. However, the m-bit retrieval sub-codes are equal in bit width to the n-bit retrieval sub-codes, i.e., m=n.

The content addressable memory 20 has plural addressable memory locations. Parts of contents are expressed by m-bit codes, respectively, and the m-bit codes are stored in the memory locations at irregularly intervals. The m-bit codes “AA” and “BB” are stored in the memory locations at address “a” and address “h” (see FIG. 12). The remaining parts of the contents are expressed by n-bit codes, respectively, and the n-bit codes are stored in the remaining addressable memory locations of the content addressable memory 20. The n-bits codes to be combined with each m-bit code are grouped so that the n-bit codes form plural code groups. The plural code groups are assigned to the memory spaces between the memory locations assigned to the m-bit codes. Thus, each m-bit code and the associated n-bit codes are stored together in the content addressable memory 20, and addresses “a”, “b”, “c”, . . . , “g”, “h”, “I”, “j”, . . . are assigned to the memory locations in the content addressable memory 20. The m-bit codes are equal in bit width to the n-bit codes, i.e., m=n. The content addressable memory 20 is searched for m-bit/n-bit codes identical with the m-bit/n-bit retrieval sub-codes under the control of the CAM controller 14.

The data memory 30 is shared between pointer values and pieces of information relating to the retrieval keys. In other words, the memory space in the data memory 30 is divided into two memory sub-spaces. Addresses a, b, c, . . . are assigned to the memory sub-space for the pointer values. Thus, the addresses assigned to the memory locations of the m-bit/n-bit codes are corresponding to the addresses where the associated pointer values are stored. On the other hand, addresses “A′+a′”, “A′+b′”, “A′+c′” are assigned to the other memory sub-space for the pieces of information. Augend “A′”, “B′”, “C′” is the pointer value for the address of the m-bit code, and addend “a′”, “b′”, “c′” . . . is the pointer value for the address of the n-bit code. Thus, the pieces of information are stored in the memory locations assigned the arithmetic addresses. In other words, the pieces of information relate to the retrieval key codes.

The controller 110 includes a retrieval key extractor 11, a retrieval key divider 12, data buffers 13a/13b, a CAM controller 14, an adder 15 and a data receiver and transmitter 16. Though not shown in FIG. 11, a signal input port is connected to the retrieval key extractor 11. A request signal for information retrieval is supplied to the retrieval key extractor 11, and the retrieval key extractor 11 extracts the N-bit retrieval code from the request signal. The retrieval key extractor 1 is connected to the retrieval key divider 12, and the N-bit retrieval code or the N-bit retrieval key is supplied from the retrieval key extractor 11 to the retrieval key divider 12. The retrieval key divider 12 divides the N-bit retrieval code into the m-bit retrieval sub-code and the n-bit retrieval sub-code, i.e., the m-bit retrieval key part and the n-bit retrieval key part.

The retrieval key divider 12 has two output ports, which are respectively connected to the data buffers 13a/13b. The m-bit retrieval sub-code is supplied to the data buffer 13a, and is stored therein. On the other hand, the n-bit retrieval sub-code is supplied to the data buffer 13b, and is stored therein. The data buffers 13a/13b are connected to the CAM controllers 14, and the m-bit retrieval sub-code and the n-bit retrieval sub-code are sequentially supplied to the CAM controller 14.

The CAM controller 14 is associated with the content addressable memory 20 and the data memory 30, and the data memory 30 is connected to the adder 15 and the data receiver and transmitter 16. The CAM controller 14 searches the associated content addressable memory 20 for an m-bit code identical with the m-bit retrieval sub-code, and specifies the address where the m-bit code is stored. The CAM controller 14 supplies the address to the data memory 30, and the pointer value is supplied from the data memory 30 to the adder 15.

The CAM controller 14 further searches the associated content addressable memory 20 for an n-bit code identical with the n-bit retrieval sub-code, and specifies the address where the n-bit code is stored. The CAM controller 14 supplies the address to the data memory 30, and the pointer value is supplied from the data memory 30 to the adder 15. The adder 15 adds the pointer values to each other, and produces the arithmetic address.

The adder 15 has an output port, which is connected to the data receiver and transmitter 16, and the arithmetic address is supplied from the adder 15 to the data receiver and transmitter 16. The data receiver and transmitter 16 accesses the memory location assigned the arithmetic address, and reads out the piece of information therefrom. The data receiver and transmitter receives the piece of information, and transmits it to the destination.

The information retrieval system behaves as follows. Assuming now that the retrieval request signal carries the retrieval key 1, i.e., the N-bit retrieval code “AAaa”, the retrieval key extractor 11 extracts the retrieval key code “AAaa” from the retrieval request signal, and supplies the retrieval key code “AAaa” to the retrieval key divider 12. The retrieval key divider 12 divides the retrieval key code “AAaa” into the m-bit retrieval sub-code “AA” and the n-bit retrieval sub-code “aa”. The m-bit retrieval sub-code “AA” and the n-bit retrieval sub-code “aa” are supplied from the retrieval key divider 12 to the data buffers 13a/13b. The m-bit retrieval sub-code “AA” and the n-bit retrieval sub-code “aa” are stored in the data buffers 13a/13b, respectively.

First, the CAM controller 14 fetches the m-bit retrieval sub-code “AA”. The CAM controller 14 searches the content addressable memory 20 for an m-bit code identical with the m-bit retrieval sub-code “AA”. The m-bit code “AA” is stored in the memory location at address “a”. When the retrieval key part “AA” is hit on the m-bit code, the content addressable memory 20 transfers the addresses “a” to the CAM controller 14. The CAM controller 14 supplies the address “a” to the data memory 30, and the pointer value “A′” is specified with the addresses “a”. The pointer value “A′” is supplied to the adder 15. The address “A′” serves as the base address. Subsequently, the CAM controller 14 fetches the n-bit retrieval sub-code “aa”. The CAM controller 14 searches the content addressable memory 20 for an n-bit code identical with the n-bit retrieval sub-code “aa”. The n-bit code “aa” is stored in the memory location at address “b”. When the retrieval key part “aa” is hit on the n-bit code, the content addressable memory 20 transfers the addresses “b” to the CAM controller 14. The CAM controller 14 supplies the address “b” to the data memory 30, and the pointer value “a′” is specified with the address “b”. The pointer value “a′” is supplied to the adder 15. The address “a′” serves as the offset address.

The adder 15 calculates the arithmetic address “A′+a′”, and supplies the arithmetic address “A′+a′” to the data receiver and transmitter 16. The thick real lines are indicative of the retrieving operation for the key part “AA” , and the broken lines are indicative of the retrieving operation for the key part “aa”.

The data receiver and transmitter 16 accesses the piece of information “1” stored at the address “A′+a′”, and the pieces of information “1” is transferred to the destination.

Although the retrieving operation is serially carried out on the content addressable memory 20 twice, the content addressable memory 20a/20 is completely searched for the m-bit code once, and is partially searched for the n-bit code. This results in reduction in time period consumed in the retrieval.

The retrieval controller 110 requires only one content addressable memory 20 and, accordingly, only one CAM controller 14, and the data memory 30 is shared between the pointer values and the pieces of information. Although the time period consumed for the search is slightly longer than that of the second embodiment, the information retrieval system implementing the fourth embodiment is simpler than the information retrieval systems implementing the second and third embodiments.

Fifth Embodiment

Turning to FIG. 13 of the drawings, still another information retrieval system embodying the present invention comprises a retrieval controller 210, a content addressable memory 20, an address memory 230a and a data memory 230b. The information retrieval system carries out a retrieving operation with a retrieval key expressed by N-bits retrieval code. Each of the retrieval keys is dividable into key parts expressed by an m-bit retrieval sub-code and an n-bit retrieval sub-code as similar to those used in the second embodiment. In this instance, the m-bit codes are much greater in bit width than the n-bit codes, i.e., m>>n, and the n-bit retrieval sub-codes are representative of off-set addresses. The N-bit retrieval codes are produced in such a manner that the n-bit retrieval sub-codes represent the offset addresses.

The content addressable memory 20 has plural addressable memory locations. Parts of contents are expressed by m-bit codes, respectively, and the m-bit codes are stored in the memory locations “a”, “b”, “c” . . . “f”, “g”, . . . (see FIG. 13). The remaining parts of the contents are converted to the n-bit retrieval sub-codes as described hereinbefore. The content addressable memory 20 is searched for an m-bit code identical with the m-bit retrieval sub-code.

The address memory 230a has plural memory locations assigned the addresses “a”, “b”, “c” . . . “f”, “g”, . . . Pointer values for the addresses of the m-bit codes are stored at the addresses identical with those assigned to the memory locations of the content addressable memory 20.

The data memory 230b has plural addressable memory locations, and pieces of information “1”, “2”, “3”, . . . “k”, “k+1”, . . . are stored in the plural addressable memory locations. The pieces of information relate to retrieval keys. Arithmetic addresses “A′+aa”, . . . “B′+bb”, . . . are assigned to the plural memory locations where the pieces of information are stored. Each of the pieces of information is to be designated by using the arithmetic address based on the pointer value and the offset address expressed by the n-bit retrieval sub-code.

The controller 110 includes a retrieval key extractor 11, a retrieval key divider 12, data buffers 13a/13b, a CAM controller 214, an adder 215 and a data receiver and transmitter 16. Though not shown in FIG. 13, a signal input port is connected to the retrieval key extractor 11. A request signal for information retrieval is supplied to the retrieval key extractor 11, and the retrieval key extractor 11 extracts the N-bit retrieval code from the request signal. The retrieval key extractor 1I1 is connected to the retrieval key divider 12, and the N-bit retrieval code or the N-bit retrieval key is supplied from the retrieval key extractor 11 to the retrieval key divider 12. The retrieval key divider 12 divides the N-bit retrieval code into the m-bit retrieval sub-code and the n-bit retrieval sub-code, i.e., the m-bit retrieval key part and the n-bit retrieval key part.

The retrieval key divider 12 has two output ports, which are respectively connected to the data buffers 13a/13b. The m-bit retrieval sub-code is supplied to the data buffer 13a, and is stored therein. On the other hand, the n-bit retrieval sub-code is supplied to the data buffer 13b, and is stored therein. The data buffer 13a is connected to the CAM controller 214, and the m-bit retrieval sub-code is supplied to the CAM controller 214. On the other hand, the data buffer 13b is connected to the adder 215, and the n-bit retrieval sub-code is supplied to the adder 215 as an addend.

The CAM controller 214 is associated with the content addressable memory 20. The CAM controller 214 is further connected to the address memory 230a, and the address memory 230a is connected to the adder 215. The CAM controller 214 searches the associated content addressable memory 20 for an m-bit code identical with the m-bit retrieval sub-code, and specifies the address where the m-bit code is stored. The CAM controller 214 supplies the address to the address memory 230a, and the pointer value is supplied from the address memory 230a to the adder 215. The adder 215 adds the pointer value to the value expressed by the n-bit retrieval sub-code, and determines an arithmetic address.

The adder 215 has an output port, which is connected to the data receiver and transmitter 16, and the arithmetic address is supplied from the adder 215 to the data receiver and transmitter 16. The data receiver and transmitter 16 accesses the memory location assigned the address identical with the arithmetic address, and reads out the piece of information therefrom. The data receiver and transmitter 16 receives the piece of information, and transmits it to the destination.

The information retrieval system behaves as follows. Assuming now that the retrieval request signal carries the retrieval key 1, i.e., the N-bit retrieval code “AAaa”, the retrieval key extractor 11 extracts the retrieval key code “AAaa” from the retrieval request signal, and supplies the retrieval key code “AAaa” to the retrieval key divider 12. The retrieval key divider 12 divides the retrieval key code “AAaa” into the m-bit retrieval sub-code “AA” and the n-bit retrieval sub-code “aa”. The m-bit retrieval sub-code “AA” and the n-bit retrieval sub-code “aa” are supplied from the retrieval key divider 12 to the data buffers 13a/13b. The m-bit retrieval sub-code “AA” and the n-bit retrieval sub-code “aa” are stored in the data buffers 13a/13b, respectively.

The CAM controller 214 fetches the m-bit retrieval sub-code “AA”. The CAM controller 214 searches the content addressable memory 20 for an m-bit code identical with the m-bit retrieval sub-code “AA”. The m-bit code “AA” is stored in the memory location at address “a”. When the retrieval key part “AA” is hit on the m-bit code, the content addressable memory 20 transfers the addresses “a” to the CAM controller 214. The CAM controller 14 supplies the address “a” to the address memory 230a, and the pointer value “A′” is specified with the addresses “a”. The pointer value “A′” is supplied to the adder 215. The address “A′” serves as the base address.

The n-bit retrieval sub-code is supplied from the data buffer 13b to the adder 215 as the addend. The adder 215 calculates the arithmetic address “A′+a′”, and supplies the arithmetic address “A′+a′” to the data receiver and transmitter 16.

The data receiver and transmitter 16 accesses the piece of information “1” stored at the address “A′+a′”, and the pieces of information “1” is transferred to the destination.

Although the n-bit retrieval sub-codes are made consistent with the offset addresses, the content addressable memory 20 is searched for the m-bit code only once. This results in reduction in time period consumed in the retrieval, and makes the time period constant regardless of the retrieval keys.

The retrieval controller 10 requires only one content addressable memory 20 and, accordingly, only one CAM controller 214. Thus, the information retrieval system implementing the fifth embodiment is simpler than the information retrieval system implementing the first embodiment.

The bit number of the n-bit retrieval sub-codes is to define the memory space in the data memory 230b together with the pointer value. If the bit number is too large, the data receiver and transmitter 16 undesirably accesses a memory location outside of the memory space.

Sixth Embodiment

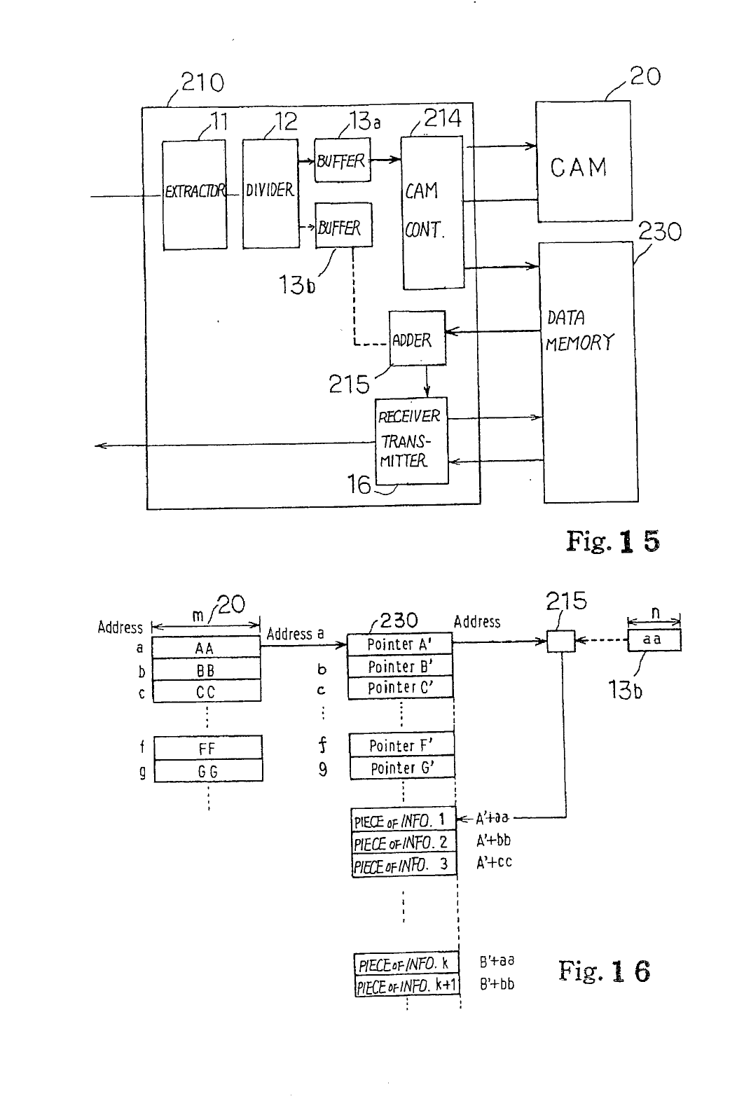

Turning to FIG. 15 of the drawings, still another information retrieval system embodying the present invention comprises a retrieval controller 210, a content addressable memory 20 and a data memory 230. The address memory 230a and the data memory 230b are replaced with a single data memory 230. The information retrieval system carries out a retrieving operation with a retrieval key expressed by N-bits retrieval code. Each of the retrieval keys is dividable into key parts expressed by an m-bit retrieval sub-code and an n-bit retrieval sub-code as similar to those used in the second embodiment. However, the m-bit retrieval sub-codes are greater in bit width than the n-bit retrieval sub-codes, i.e., m>>n. and the n-bit retrieval sub-codes are representative of offset addresses. The N-bit retrieval codes are produced in such a manner that the n-bit retrieval sub-codes represent the offset addresses.

The content addressable memory 20 has plural addressable memory locations. Parts of contents are expressed by m-bit codes, respectively, and the m-bit codes are stored in the memory locations “a”, “b”, “c” . . . “f”, “g”, . . . (see FIG. 16). The remaining parts of the contents are converted to the n-bit retrieval sub-codes, and the n-bit retrieval sub-codes serve as the offset address as described hereinbefore. The content addressable memory 20 is searched for an m-bit code identical with the m-bit retrieval sub-code.

The data memory 230 has two memory spaces, one of which is assigned to pointer values, and the other of which is assigned to pieces of information relating to the retrieval keys. The first memory space has plural memory locations assigned the addresses “a”, “b”, “c” . . . “f”, “g”, . . . and pointer values for the addresses of the m-bit codes are stored at the addresses identical with those assigned to the memory locations of the content addressable memory 20.

The second memory space also has plural addressable memory locations, and pieces of information “1”, “2”, “3”, . . . “k”, “k+1” . . . are stored in the plural addressable memory locations. The pieces of information relate to retrieval keys. Arithmetic addresses “A′+aa”, . . . “B′+bb”, . . . are assigned to the plural memory locations where the pieces of information are stored. Each of the pieces of information is to be designated by using the arithmetic address based on the pointer value and the offset address expressed by the n-bit retrieval sub-code.

The controller 210 includes a retrieval key extractor 11, a retrieval key divider 12, data buffers 13a/13b, a CAM controller 214, an adder 215 and a data receiver and transmitter 16. Though not shown in FIG. 15, a signal input port is connected to the retrieval key extractor 11. A request signal for information retrieval is sup plied to the retrieval key extractor 11, and the retrieval key extractor 11 extracts the N-bit retrieval code from the request signal. The retrieval key extractor 1 is connected to the retrieval key divider 12, and the N-bit retrieval code or the N-bit retrieval key is supplied from the retrieval key extractor 11 to the retrieval key divider 12. The retrieval key divider 12 divides the N-bit retrieval code into the m-bit retrieval sub-code and the n-bit retrieval sub-code, i.e., the m-bit retrieval key part and the n-bit retrieval key part.

The retrieval key divider 12 has two output ports, which are respectively connected to the data buffers 13a/13b. The m-bit retrieval sub-code is supplied to the data buffer 13a, and is stored therein. On the other hand, the n-bit retrieval sub-code is supplied to the data buffer 13b, and is stored therein. The data buffer 13a is connected to the CAM controller 214, and the m-bit retrieval sub-code is supplied to the CAM controller 214. On the other hand, the data buffer 13b is connected to the adder 215, and the n-bit retrieval sub-code is supplied to the adder 215 as an addend.

The CAM controller 214 is associated with the content addressable memory 20. The CAM controller 214 is further connected to the data memory 230, and the data memory 230 is connected to the adder 215 and the receiver and transmitter 16. The CAM controller 214 searches the associated content addressable memory 20 for an m-bit code identical with the m-bit retrieval sub-code, and specifies the address where the m-bit code is stored. The CAM controller 214 supplies the address to the data memory 230, and the pointer value is supplied from the data memory 230 to the adder 215. The adder 215 adds the pointer value to the value expressed by the n-bit retrieval sub-code, and determines an arithmetic address.

The adder 215 has an output port, which is connected to the data receiver and transmitter 16, and the arithmetic address is supplied from the adder 215 to the data receiver and transmitter 16. The data receiver and transmitter 16 accesses the memory location assigned the address identical with the arithmetic address, and reads out the piece of information therefrom. The data receiver and transmitter 16 receives the piece of information, and transmits it to the destination.

The information retrieval system behaves as follows. Assuming now that the retrieval request signal carries the retrieval key 1, i.e., the N-bit retrieval code “AAaa”, the retrieval key extractor 11 extracts the retrieval key code “AAaa” from the retrieval request signal, and supplies the retrieval key code “AAaa” to the retrieval key divider 12. The retrieval key divider 12 divides the retrieval key code “AAaa” into the m-bit retrieval sub-code “AA” and the n-bit retrieval sub-code “aa”. The m-bit retrieval sub-code “AA” and the n-bit retrieval sub-code “aa” are supplied from the retrieval key divider 12 to the data buffers 13a/13b. The m-bit retrieval sub-code “AA” and the n-bit retrieval sub-code “aa” are stored in the data buffers 13a/13b, respectively.

The CAM controller 214 fetches the m-bit retrieval sub-code “AA”. The CAM controller 214 searches the content addressable memory 20 for an m-bit code identical with the m-bit retrieval sub-code “AA”. The m-bit code “AA” is stored in the memory location assigned address “a”. When the retrieval key part “AA” is hit on the m-bit code, the content addressable memory 20 transfers the addresses “a” to the CAM controller 214. The CAM controller 14 supplies the address “a” to the data memory 230, and the pointer value “A′” is specified with the addresses “a”. The pointer value “A′” is supplied to the adder 215. The address “A′” serves as the base address.

The n-bit retrieval sub-code is supplied from the data buffer 13b to the adder 215 as the addend. The adder 215 calculates the arithmetic address “A′+a′”, and supplies the arithmetic address “A′+a′” to the data receiver and transmitter 16.

The data receiver and transmitter 16 accesses the piece of information “1” stored at the address “A′+a′”, and the pieces of information “1” is transferred to the destination.

Although the n-bit retrieval sub-codes are made consistent with the offset addresses, the content addressable memory 20 is searched for the m-bit code only once. This results in reduction in time period consumed in the retrieval, and makes the time period constant regardless of the retrieval keys.

The retrieval controller 110 requires only one content addressable memory 20, accordingly, only one CAM controller 214 and only one data memory 230. Thus, the information retrieval system implementing the sixth embodiment is simpler than the information retrieval system implementing the fourth embodiment.

Seventh Embodiment

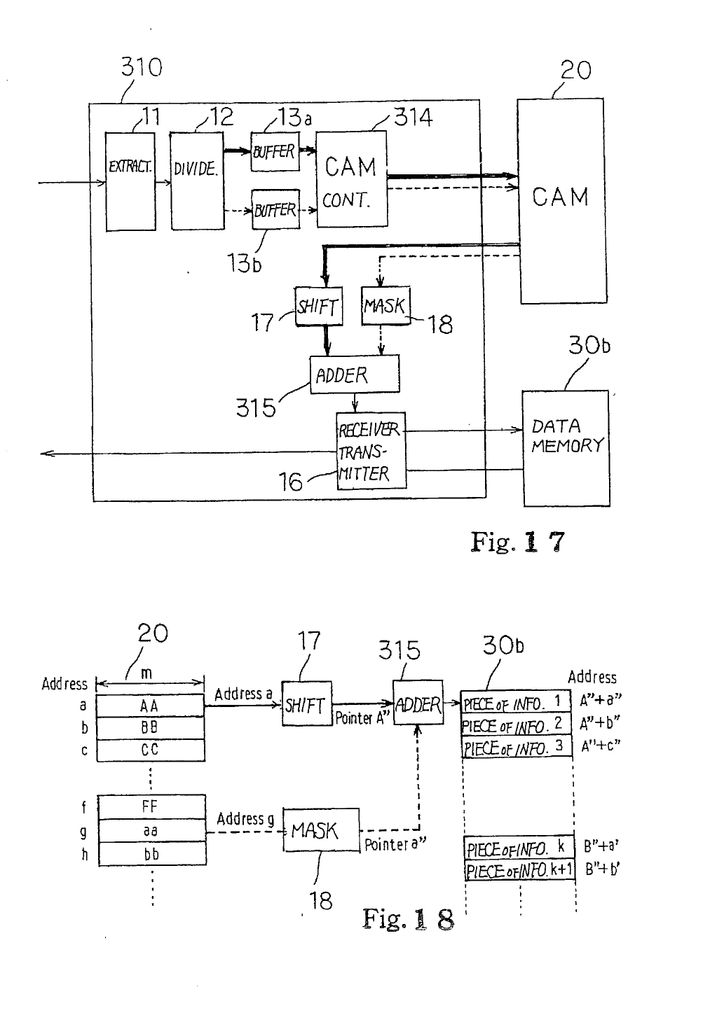

Turning to FIG. 17 of the drawings, still another information retrieval system embodying the present invention comprises a retrieval controller 310, a content addressable memory 20 and a data memory 30b. The information retrieval system carries out a retrieving operation with a retrieval key expressed by N-bits retrieval code. Each of the retrieval keys is dividable into key parts expressed by an m-bit retrieval sub-code and an n-bit retrieval sub-code. In this instance, the m-bit codes are equal in bit width to the n-bit codes, i.e., m=n.

The content addressable memory 20 has plural addressable memory locations. Parts of contents are expressed by m-bit codes, respectively, and the m-bit codes are stored in the memory locations “a”, “b”, “c” . . . The remaining parts of the contents are expressed by n-bit codes, respectively, and the n-bit codes are stored in the memory locations “f”, “g”, “h”, . . . (see FIG. 18). Each of the n-bit codes has low-order bits representative of the offset address. The content addressable memory 20 is searched for m-bit/n-bit codes identical with the m-bit/n-bit retrieval sub-codes.

The data memory 30b has plural addressable memory locations, and pieces of information “1”, “2”, “3”, . . . “k”, “k+1”, . . . are stored in the plural addressable memory locations. The pieces of information relate to retrieval keys. Arithmetic addresses “A”+a″, . . . “B”+b″, . . . are assigned to the plural memory locations where the pieces of information are stored. Each of the pieces of information is to be designated by using the arithmetic address based on the pointer value and the offset address expressed by the low-order bits of the n-bit retrieval sub-code.

The controller 110 includes a retrieval key extractor 11, a retrieval key divider 12, data buffers 13a/13b, a CAM controller 314, a shifter 17, a mask circuit 18, an adder 215 and a data receiver and transmitter 16. Though not shown in FIG. 17, a signal input port is connected to the retrieval key extractor 11. A request signal for information retrieval is supplied to the retrieval key extractor 11, and the retrieval key extractor 11 extracts the N-bit retrieval code from the request signal. The retrieval key extractor 11 is connected to the retrieval key divider 12, and the N-bit retrieval code or the N-bit retrieval key is supplied from the retrieval key extractor 11 to the retrieval key divider 12. The retrieval key divider 12 divides the N-bit retrieval code into the m-bit retrieval sub-code and the n-bit retrieval sub-code, i.e., the m-bit retrieval key part and the n-bit retrieval key part.

The retrieval key divider 12 has two output ports, which are respectively connected to the data buffers 13a/13b. The m-bit retrieval sub-code is supplied to the data buffer 13a, and is stored therein. On the other hand, the n-bit retrieval sub-code is supplied to the data buffer 13b, and is stored therein. The data buffers 13a/13b are connected to the CAM controller 314, and the CAM controller 314 sequentially fetches the m-bit retrieval sub-code and the n-bit retrieval sub-code.

The CAM controller 314 is associated with the content addressable memory 20, and repeats the retrieval twice. The content addressable memory 20 is searched for an m-bit code identical with the m-bit retrieval sub-code and for an n-bit code identical with the n-bit retrieval sub-code. In FIG. 17, thick real lines are indicative of the flow of the retrieval operation for the m-bit code, and broken lines indicate the flow of the retrieval operation for the n-bit code.

The content addressable memory 20 is connected to the shifter 17 and the mask circuit 18, and the shifter 17 and the mask circuit 18 are connected to the adder 315. When the address for an m-bit code identical with the m-bit retrieval sub-code is read out from the content addressable memory 20, the address code is shifted in the shifter 17 by predetermined bits toward the most significant bit. The address expressed by the shifted address code serves as the base address. On the other hand, when an address for an n-bit code identical with the n-bit retrieval sub-code is read out from the content addressable memory 20, high-order bits of the address code are masked, and the partially masked address code is representative of the offset address.

The base address and the offset address are supplied to the adder 315, and the adder 315 adds the offset address to the base address so as to produce an arithmetic address. The adder 315 has an output port, which is connected to the data receiver and transmitter 16, and the arithmetic address is supplied from the adder 315 to the data receiver and transmitter 16. The data receiver and transmitter 16 accesses the memory location assigned the address identical with the arithmetic address, and reads out the piece of information therefrom. The data receiver and transmitter 16 receives the piece of information, and transmits it to the destination.

The information retrieval system behaves as follows. Assuming now that the retrieval request signal carries the retrieval key 1, i.e., the N-bit retrieval code “AAaa”, the retrieval key extractor 11 extracts the retrieval key code “AAaa” from the retrieval request signal, and supplies the retrieval key code “AAaa” to the retrieval key divider 12. The retrieval key divider 12 divides the retrieval key code “AAaa” into the m-bit retrieval sub-code “AA” and the n-bit retrieval sub-code “aa”. The m-bit retrieval sub-code “AA” and the n-bit retrieval sub-code “aa” are supplied from the retrieval key divider 12 to the data buffers 13a/13b. The m-bit retrieval sub-code “AA” and the n-bit retrieval sub-code “aa” are stored in the data buffers 13a/13b, respectively.

The CAM controller 214 fetches the m-bit retrieval sub-code “AA” from the data buffer 13a. The CAM controller 214 searches the content addressable memory 20 for an m-bit code identical with the m-bit retrieval sub-code “AA”. The m-bit code “AA” is stored in the memory location at address “a”. When the retrieval key part “AA” is hit on the m-bit code, the content addressable memory 20 transfers the addresses “a” to the shifter 17. The address code representative of the address “a” is shifted toward the most significant bit by the predetermined bits, and the shifted address code expresses the base address “A″″”. The base address “A″” is supplied to the adder 315.

The CAM controller 214 fetches the n-bit sub-code “aa” from the data buffer 13b, and searches the content addressable memory 20 for an n-bit code identical with the n-bit retrieval sub-code. The n-bit code “aa” is stored in the memory location assigned the address “g”. When the n-bit retrieval sub-code is hit on the n-bit code, the address “g” is supplied from the content addressable memory 20 to the mask circuit 18. The high-order bits of the address code representing the address “g” are masked, and the partially masked address code, i.e., the offset address “a″” is supplied from the mask circuit 18 to the adder 315.

The adder 315 calculates the arithmetic address “A″+a″”, and supplies the arithmetic address “A″+a″” to the data receiver and transmitter 16.

The data receiver and transmitter 16 accesses the piece of information “1” stored at the address “A′+a′”, and the pieces of information “1” is transferred to the destination.

Although the information retrieval system implementing the seventh embodiment carries out the retrieving operation on the content addressable memory 20 twice, the retrieving operation is completed within a time shorter than that of the prior art information retrieval system, and only two memories 20/30b are required. Thus, the memory capacity is drastically reduced in the information retrieval system implementing the seventh embodiment.

As will be appreciated from the foregoing description, the information retrieval system according to the present invention achieves the following advantages.

First, the content addressable memory is searched for each retrieval key part independent of the search for another retrieval key part. This results in reduction of the time period consumed for the information retrieval. In the embodiments which have the content addressable memories separately assigned the retrieval key parts, the controllers search the associated content addressable memories in parallel for the retrieval key parts so that the retrieval is quickly completed in a constant time period. Even if the content addressable memories are less than the number of retrieval key parts, the retrieval sequence is suitable for pipeline content addressable memory or memories, and the retrieval is completed within a short time period.

Second, the combinations of the m-bit/n-bit codes are corresponding to the retrieval keys. This feature is preferable from the viewpoint of reduction in memory capacity, because the parts of the contents are respectively stored in the memory locations without duplication. For example, the retrieval key 1 has the n-bit code identical with the n-bit code of the retrieval key 3 (see FIG. 7). In the prior art information retrieval system, the m-bit codes “AA” and “BB” are stored in a content addressable memory, and the n-bit code “aa” is stored in another content addressable memory twice. On the other hand, although two memory locations are required for the m-bit codes “AA” and “BB”, the n-bit code “aa” is registered in only one memory location in the information retrieval system according to the present invention.

Third, the registration of the contents is simplified in the information retrieval with a memory space assigned to pointer values. This is because of the fact that the contents are independent of the addresses assigned to the pieces of information relating the contents.

Finally, the address memory is partially or completely replaceable with suitable circuit or circuits. In those embodiments, the memory capacity to be required is reduced.

Each of the content addressable memories 2a/2b, 20a/20b, 20 serves as a first memory, and the data memory 4/30b/230b/30b or the memory space in the data memory 30/230 is corresponding to a second memory. An address generating unit is implemented by the combination of the address determining unit and the controller 3/5, the combination of the address memory and the retrieval controller 30a/10, 30a/110, 230a/210, the combination of the memory space in the data memory and the retrieval controller 30/110, 230/ 210 or only the retrieval controller 310.

Although particular embodiments of the present invention have been shown and described, it will be apparent to those skilled in the art that various changes and modifications may be made without departing from the spirit and scope of the present invention.

For example, retrieval keys may be divided into more than two key parts. In this instance, each of the contents is divided into more than two sub-codes, and are independently stored in the content addressable memories, respectively. The retrieval is carried out in parallel, and is completed within a predetermined time period.

The CAM controller may searches the content addressable memory for an n-bit code identical with the n-bit retrieval sub-code and, thereafter, for an m-bit code identical with the m-bit retrieval sub-code.

The adder is incorporated in the above-described embodiments. However, the adder is replaceable with any kind of arithmetic circuit in so far as the arithmetic circuit specifies the address to be accessed through the predetermined arithmetic or logic operation.

What is claimed is:

1. An information retrieval system for selecting a piece of information relating to a retrieval key code dividable into plural retrieval sub-codes, comprising:
a first memory including plural memory spaces respectively storing plural groups of content codes equal in bit width to said plural retrieval sub-codes, and responsive to said plural retrieval sub-codes so as to output plural address codes representative of memory locations respectively selected from said plural memory spaces, content codes identical with said plural retrieval sub-codes being stored in said memory locations;
a second memory having plural addressable memory locations for storing pieces of information, and responsive to a target address so as to select said piece of information relating to said retrieval key code from said pieces of information; and
an address generating unit connected to said first memory and said second memory, and generating said target address through an arithmetic operation on said address codes so as to supply said target address to said second memory.

2. The information retrieval system as set forth in claim 1, in which said address generating unit generates said target address further through an indirect addressing with said address codes.

3. The information retrieval system as set forth in claim 2, in which said address generating unit includes
an address memory having plural addressable memory locations for storing said values together with other values and responsive to said address codes so as to output said values from the addressable memory locations specified by said address codes, and
an arithmetic circuit connected to said address memory and said second memory and generating said target address from said values for supplying said target address to said second memory.

4. The information retrieval system as set forth in claim 3, in which said arithmetic circuit carries out an addition between said values.

5. The information retrieval system as set forth in claim 2, in which said address generating unit includes
an address memory having plural addressable memory locations for storing at least one of said values together with other values and responsive to at least one of said address codes so as to output said at least one of said values from at least one addressable memory location specified by said at least one of said address codes,
an address converter supplied with at least one of said plural retrieval sub-codes for generating the remaining values, and
an arithmetic circuit connected to said address memory and said address converter and generating said target address from said at least one of said values and said remaining values for supplying said target address to said second memory.

6. The information retrieval system as set forth in claim 5, in which said address converter is a data buffer for storing said at least one of said plural retrieval sub-codes.

7. The information retrieval system as set forth in claim 5, in which said arithmetic circuit carries out an addition between said at least one of said values and said remaining values.

8. The information retrieval system as set forth in claim 2, in which said address generating unit includes
an address converter connected to said first memory and converting said address codes to modified codes representative of said values, and
an arithmetic circuit connected to said address converter and generating said target address from said values for supplying said target address to said second memory.

9. The information retrieval system as set forth in claim 8, in which said address converter includes
a shifter connected to said first memory and shifting at least one of said address codes for generating one of said modified codes, and
a mask circuit connected to said first memory and masking predetermined order-bits of another of said address codes for generating another of said modified codes.

10. The information retrieval system as set forth in claim 8, in which said arithmetic circuit is implemented by an adder supplied with said modified codes for generating said target address.

11. The information retrieval system as set forth in claim 1, in which said plural memory spaces are created in plural memory units independent of one another, and said address generating unit includes plural memory controller associated with said plural memory units so as to access to said address codes substantially in parallel.

12. The information retrieval system as set forth in claim 11, in which said address generating unit includes
an address memory including plural memory spaces spaced from one another by a distance corresponding to certain addresses and having plural groups of addressable memory locations for storing said values together with other values,
a controller connected to said first memory and said address memory and responsive to one of said address codes for reading out one of said values from one of said plural memory spaces and calculating a modified address codes on the basis of another of said address codes and said certain addresses for reading out another of said values from another of said plural memory spaces, and
an arithmetic circuit connected to said address memory and generating said target address from said values for supplying said target address to said second memory.

13. The information retrieval system as set forth in claim 12, in which said arithmetic circuit carries out an addition between said at least one of said values and said another of said values.

14. The information retrieval system as set forth in claim 1, in which said plural memory locations of said first memory is created in a single memory device, and said first memory supplies said address codes in serial to said address generating unit.

15. The information retrieval system as set forth in claim 14, in which one of said plural memory spaces have a certain number of addressable memory locations and assigned to different codes representative of one of said plural retrieval sub-codes, and another of said plural memory spaces is divided into plural memory sub-spaces for storing plural groups of codes representative of another of said plural retrieval sub-codes, wherein said plural memory sub-spaces are alternated with said certain number of addressable memory locations in said one of said plural memory spaces.

16. The information retrieval system as set forth in claim 15, in which said address generating unit includes
an address memory having plural addressable memory locations for storing said values together with other values and responsive to said address codes so as to output said values from the addressable memory locations specified by said address codes, and
an arithmetic circuit connected to said address memory and generating said target address from said values for supplying said target address to said second memory.

17. The information retrieval system as set forth in claim 16, in which said arithmetic circuit carries out an addition between said values.
